(19) United States
(12) Patent Application Publication
(10) Pub. No.: US 2025/0348794 A1
(43) Pub. Date: Nov. 13, 2025

(54) SYSTEM AND METHOD FOR GENERATING COMPETING MODELS IN RASHOMON SETS FOR GRADIENT BOOSTING

(71) Applicant: JPMORGAN CHASE BANK, N.A., New York, NY (US)

(72) Inventors: Hsiang HSU, Boston, MA (US); Shubham SHARMA, Manhattan, NY (US); Ivan BRUGERE, Des Plaines, IL (US); Freddy LECUE, Mamaroneck, NY (US); Richard CHEN, Baldwin Place, NY (US)

(21) Appl. No.: 18/658,656

(22) Filed: May 8, 2024

(51) Int. Cl. G06N 20/20

(52) U.S. Cl. CPC G06N 20/20

(57) ABSTRACT

A method may include: receiving a dataset comprising a plurality of samples and a loss function; training a first number first machine learning models using the dataset comprising, wherein each of the first machine learning models has a similar performance; selecting one of the first machine learning models with a smallest loss; computing a residual for each of the plurality of samples using the one first machine learning model; defining a new dataset comprising the plurality of samples and the residual for each samples; training the first machine learning model with the new dataset; generating a second plurality of machine learning models by repeating the selecting, the computing, the defining, and training for a number of boosting iterations; selecting a subset of the second plurality of machine learning model models having a specified property; and deploying the subset of second machine learning models to a downstream task.

### BACKGROUND OF THE INVENTION

### 1. Field of the Invention

Embodiments relate to systems and methods for generating competing models in Rashomon sets for gradient boosting.

### 2. Description of the Related Art

Ensemble learning constructs a predictive model by amalgamating the predictions of multiple base models, often referred to as weak learners, culminating in a potent “committee” boasting enhanced predictive prowess. The combination of these base models can occur in parallel or sequentially, giving rise to various ensemble techniques such as bagging (bootstrap aggregating), random forest, and boosting. As averaging models reduces model variance, ensemble learning inherently diminishes predictive multiplicity, and have been reported in several literature.

For example, in Black, Emily, Klas Leino, and Matt Fredrikson, “Selective ensembles for consistent predictions,” arXiv preprint arXiv: 2111.08230 (2021), the disclosure of which is incorporated by reference in its entirety, proposes a selective ensemble that leverages certifiably-robust predictions to mitigate the problem of inconsistency (measured by the rate of disagreement) with a probabilistic guarantee.

Exploration of Rashomon sets in current research primarily targets specialized hypothesis spaces like sparse decision-trees, linear models, and neural networks. Hsu, Hsiang, and Flavio Calmon, “Rashomon capacity: A metric for predictive multiplicity in classification,” Advances in Neural Information Processing Systems 35:28988-29000 (2022), the disclosure of which is incorporated by reference in its entirety, notes that random forest classifiers exhibit a lower Rashomon capacity compared to decision tree classifiers. Furthermore, Long, Carol Xuan, Hsiang Hsu, Wael Alghamdi, and Flavio P. Calmon, “Arbitrariness lies beyond the fairness-accuracy frontier,” arXiv preprint arXiv: 2306.09425 (2023), the disclosure of which is incorporated by reference in its entirety, demonstrated that the probability of significant deviations in the ensembled predictions diminishes exponentially.

### SUMMARY OF THE INVENTION

Systems and methods for generating competing models in Rashomon sets for gradient boosting are disclosed. According to an embodiment, a method may include: (1) receiving, by a computer program, a dataset comprising a plurality of samples and a loss function; (2) training, by the computer program, a first number of a plurality of first machine learning models using the dataset, wherein each of the plurality of first machine learning models has a similar performance as measured by the loss function; (3) selecting, by the computer program, one of the first machine learning models with a smallest loss using the loss function; (4) computing, by the computer program, a residual for each of the plurality of samples using the one first machine learning model; (5) defining, by the computer program, a new dataset comprising the plurality of samples and the residual for each samples; (6) training, by the computer program, the first machine learning model with the new dataset; (7) generating, by the computer program, a second plurality of machine learning models by repeating the selecting, the computing, the defining, and training for a number of boosting iterations, wherein a number of second machine learning models is equal to the first number multiplied by the number of boosting iterations; (8) selecting, by the computer program, a subset of the second plurality of machine learning model models having a specified property; and (9) deploying, by the computer program, the subset of second machine learning models to a downstream task.

In one embodiment, the computer program further receives the number of boosting iterations.

In one embodiment, the method may also include: receiving, by the computer program, a hypothesis space comprising one of sparse decision-trees, linear models, and neural networks.

In one embodiment, the first plurality of machine learning models may be trained with different initializations or different random seeds to fit the dataset.

In one embodiment, the specified property may include fairness, and fairness may be measured using a statistical parity for the plurality of second machine learning models.

In one embodiment, the specified property may include interpretability, and interpretability may be measured using a SHapley Additive explanations value for each of the plurality of second machine learning models.

In one embodiment, the method may also include: computing, by the computer program, a predictive multiplicity metric for the second plurality of machine learning models, wherein the predictive multiplicity metric measures conflicting predictions among the second plurality of machine learning models.

According to another embodiment, a non-transitory computer readable storage medium, may include instructions stored thereon, which when read and executed by one or more computer processors, cause the one or more computer processors to perform steps comprising: receiving a dataset comprising a plurality of samples and a loss function; training a first number of a plurality of first machine learning models using the dataset, wherein each of the plurality of first machine learning models has a similar performance as measured by the loss function; selecting one of the first machine learning model with a smallest loss using the loss function; computing a residual for each of the plurality of samples using the one first machine learning models; defining a new dataset comprising the plurality of samples and the residual for each samples; training the first machine learning model with the new dataset; generating a second plurality of machine learning models by repeating the selecting, the computing, the defining, and the training for a number of boosting iterations, wherein a number of second machine learning models is equal to the first number multiplied by the number of boosting iterations; selecting a subset of the second plurality of machine learning model models having a specified property; and deploying the subset of second machine learning models to a downstream task.

In one embodiment, the non-transitory computer readable storage medium may also include instructions stored thereon, which when read and executed by one or more computer processors, cause the one or more computer processors to receive the number of boosting iterations.

In one embodiment, the non-transitory computer readable storage medium may also include instructions stored thereon, which when read and executed by one or more computer processors, cause the one or more computer processors to perform steps comprising: receiving a hypothesis space comprising one of sparse decision-trees, linear models, and neural networks.

In one embodiment, the first plurality of machine learning models may be trained with different initializations or different random seeds to fit the dataset.

In one embodiment, the specified property may include fairness, and fairness may be measured using a statistical parity for the plurality of second machine learning models.

In one embodiment, the specified property may include interpretability, and interpretability may be measured using a SHapley Additive explanations value for each of the plurality of second machine learning models.

In one embodiment, the non-transitory computer readable storage medium may also include instructions stored thereon, which when read and executed by one or more computer processors, cause the one or more computer processors to perform steps comprising: computing a predictive multiplicity metric for the second plurality of machine learning models, wherein the predictive multiplicity metric measures conflicting predictions among the second plurality of machine learning models.

According to another embodiment, a system may include: a database storing a dataset; a user electronic device; and an electronic device executing a computer program that may be configured to receive the dataset from the database and a loss function from the user electronic device; to train a first number of a plurality of first machine learning models using a dataset comprising a plurality of samples with different initializations or different random seeds to fit the dataset, wherein each of the plurality of first machine learning models has a similar performance as measured by the loss function; to select one of the first machine learning model with a smallest loss using the loss function; to compute a residual for each of the plurality of samples using the one first machine learning model; to define a new dataset comprising the plurality of samples and the residual for each samples; to train the first machine learning model with the new dataset; to generate a second plurality of machine learning models by repeating the selecting, the computing, the defining, and the training for a number of boosting iterations, wherein a number of second machine learning models is equal to the first number multiplied by the number of boosting iterations; to select a subset of the second plurality of machine learning model models having a specified property; and to deploy the subset of second machine learning models to a downstream task.

In one embodiment, the computer program further receives the number of boosting iterations.

In one embodiment, the computer program may be further configured to receive a hypothesis space comprising one of sparse decision-trees, linear models, and neural networks.

In one embodiment, the specified property may include fairness, and fairness may be measured using a statistical parity for the plurality of second machine learning models.

In one embodiment, the specified property may include interpretability, and interpretability may be measured using a SHapley Additive explanations value for each of the plurality of second machine learning models.

In one embodiment, the computer program may be further configured to compute a predictive multiplicity metric for the second plurality of machine learning models, wherein the predictive multiplicity metric measures conflicting predictions among the second plurality of machine learning models.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for generating competing models in Rashomon sets for gradient boosting according to an embodiment;

FIGS. 2A and 2B illustrate a method for generating competing models in Rashomon sets for gradient boosting according to an embodiment;

FIG. 3 depicts an illustrative example of the process of FIGS. 2A and 2B; and

FIG. 4 depicts an exemplary computing system for implementing aspects of the present disclosure.

### DETAILED DESCRIPTION OF PREFERRED EMBODIMENTS

Embodiments relate to systems and methods for accelerating Rashomon set exploration in gradient boosting.

The use of boosting algorithms is a powerful technique in machine learning that iteratively constructs a strong predictive model by combining the outputs of multiple weak learners (i.e., machine learning models), such as machine learning models with a simple architecture (e.g., shallow decision trees, linear models, etc.). For example, the weak learners may have the same architecture, but may have different detailed structures. For example, the weak learners may be decision trees with depth 4 but may have different number of leaves.

Unlike traditional ensemble methods that give equal weight to all base models, boosting assigns varying weights to each weak learner based on its performance. At each iteration, boosting focuses on the instances misclassified by the previous models, allowing subsequent models to correct their mistakes effectively. Through this iterative process, boosting gradually improves the overall predictive accuracy, often outperforming individual models and other ensemble methods.

The part of the data that cannot be explained by the previous model is called the (pseudo-) residual; in each boosting iteration, the weak learning aims to fit the residual from the previous stage. Learning the residual itself at each boosting iteration includes the Rashomon effect, i.e., there are many weak learners that could fit the residual with similar performance. Thus, if there are K boosting iterations, M models may be trained at each boosting iteration, thus training K×M models. By iteratively expanding models in the Rashomon set for each residual, however the result is M^{K} models. These models can then be used to perform predictive multiplicity metric estimation or model selection.

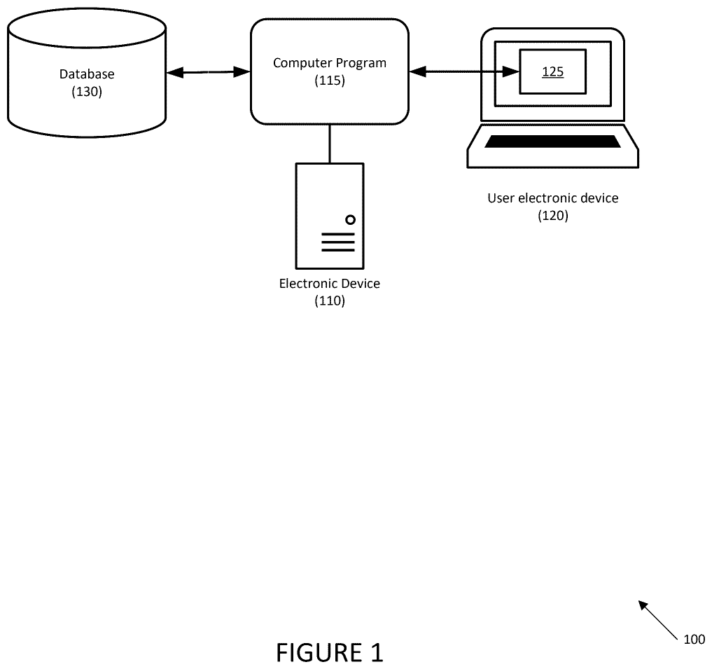

Referring to FIG. 1, a system for generating competing models in Rashomon sets for gradient boosting is disclosed according to an embodiment. System 100 may include electronic device 110, which may be a server (e.g., physical and/or cloud-based), computers (e.g., workstations, desktops, laptops, notebooks, tablets, etc.), smart devices, Internet of Things (IoT) appliances, etc. Electronic device 110 may execute computer program 115, such as a model generation computer program, which may receive a dataset from database 130, train a plurality of models with the dataset, a loss function, and a hypothesis space, such as a class of models of a specific architecture. For example, all linear models of 10 dimensions compose a hypothesis class.

A dataset may include a plurality (n) of samples, wherein each sample includes a pair (x, y), where x is the feature, and y is the target. For example, in an income prediction task, x is the demographic information of a person, and y is the income.

It may then use boosting to generate additional models based on the original models.

The models may be available to user computer program 125 executed by user electronic device 120.

The loss function may compute the distance between the output of the models, and an expected output of the models.

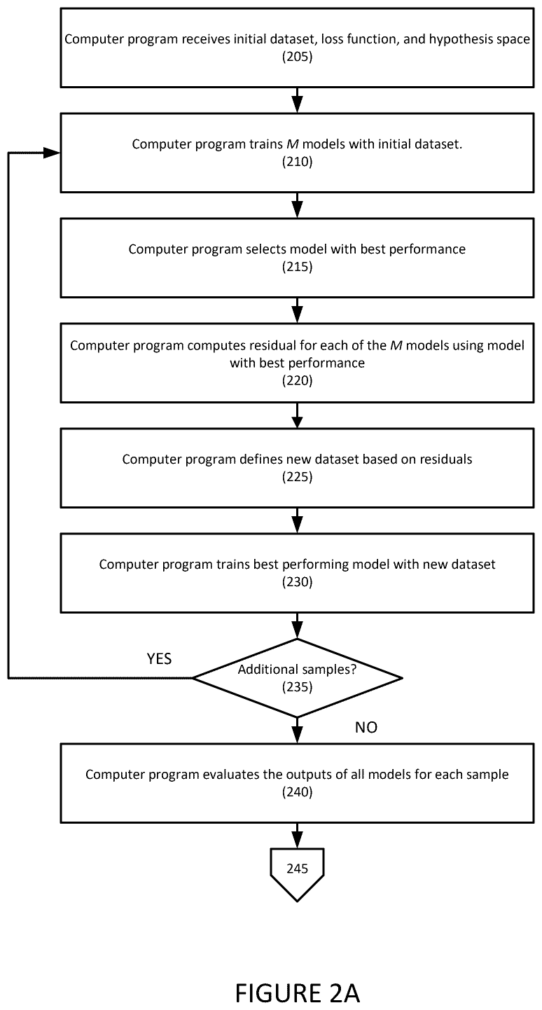

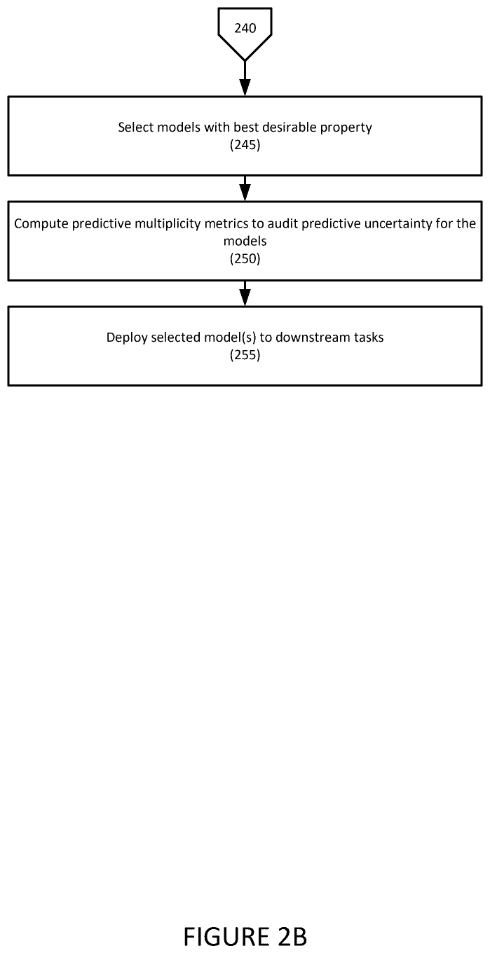

Referring to FIGS. 2A and 2B, a method for generating competing models in Rashomon sets for gradient boosting is disclosed according to an embodiment.

In step 205, a computer program may receive a dataset (including a plurality (n) of samples including a data feature (x) and a data target (y)), a loss function, and a hypothesis space. The computer program may also receive a number of boosting iterations, K, which may be a pre-set parameter. For example, the dataset, [symbol] , the loss function [symbol] , and the hypothesis space may be defined as follows:

$${0}_{} = {\{ {x}_{i} , {y}_{i} \}}_{i = 1}^{n} \\ ℓ : \times \to {+}^{} \\ : \to$$

where: xᵢ is a data feature (e.g., an image);
yᵢ, is the corresponding label for the data feature (e.g., a dog);
n is the number of samples (or size of the dataset);
i is the index for the number of samples;
[symbol] is the set of all possible labels;
[symbol] is the hypothesis space of decision trees, i.e.,

$${h}_{1}^{0} , {h}_{2}^{0} , … , {h}_{M}^{0}$$

∈ [symbol]
; and
X is the set of all possible data features.

In step 210, the computer program may train a number of a plurality of first models, M, using the samples. The models may be weak learners as described above. Each model may be trained with, for example, different initializations, different random seeds, etc. to fit the samples in the dataset.

In one embodiment, the M models may have similar performance as evaluated by the loss function. For example,

$$\frac{1}{n} {\sum }_{i = 1}^{n} ℓ ( {h}_{m}^{0} ( {x}_{i} ) , {y}_{i} ) \leq ϵ , for m = 1 , 2 , … , M .$$

In step 215, the computer program may select the model of the plurality of models with the best performance (i.e., having the smallest loss). For example, model

$${h}_{1}^{0}$$

may have the best performance.

In step 220, the computer program may compute the residual, r, for each sample. For example,

$${r}_{i}^{1} = - {∇}_{{h}_{1}^{0}} [ ℓ ( {h}_{1}^{0} ( {x}_{i} ) , {y}_{i} ) ]$$

where

$${∇}_{{h}_{1}^{0}}$$

is the gradient regarding the model having the best performance

$$( e . g . , {h}_{1}^{0} ) .$$

The residual is the difference between the predicted output of the model for each sample, and the actual output of the models.

Note that if the loss function is

$$ℓ ( {h}_{1}^{0} ( {x}_{i} ) , {y}_{i} ) = {( {h}_{1}^{0} ( {x}_{i} ) - {y}_{i} )}^{2} ,$$

the residual becomes a special case of

$${r}_{i}^{1} = 2 ( {y}_{i} - {h}_{1}^{0} ( {x}_{i} ) ) .$$

In step 225, the computer program may define a new dataset, [symbol] , based on the residuals. For example,

$${𝒮}_{1} = {\{ {x}_{i} , {r}_{i}^{1} \}}_{i = 1}^{n}$$

In step 230, the computer program may train, or fit, the best performing model with the new data set.

In step 235, if there are additional boosting iterations (i.e., i<K), the process may return to step 210.

If the number of boosting iterations has been met, then in step 240, the computer program may evaluate the outputs of all models from all boosting iterations for each sample. For example,

$${h}_{m}^{k} ( {x}_{i} )$$

for all m=1, . . . , M, for all i=1, . . . , N and for all k=1, . . . , K Thus, there are K iterations, and, in each iteration, M models are trained, yielding a second plurality of models, i.e., K×M models.

For each boosting iteration, there are M models to be selected. Therefore, there are M^{K} models in total for each sample.

In step 245, the computer program may select the model(s) with the best desirable property, such as fairness, interpretability, etc. from the M^{K} models. In one embodiment, the best desirable property may be identified by the user.

For example, interpretability (e.g., the ability to explain the results of the output of the machine learning models) may be measured from the SHAP (SHapley Additive exPlanations) value for each model. An example of SHAP is disclosed in Lundberg, Scott M., and Su-In Lee, “A unified approach to interpreting model predictions,” Advances In Neural Information Processing Systems 30 (2017), the disclosure of which is hereby incorporated, by reference, in its entirety.

Fairness, which may be the impact of bias on the outputs of the machine learning models, may be measured using fairness metrics, such as the statistical parity and mean equalized odds for each model. An example of such is disclosed in Alghamdi, Wael, Hsiang Hsu, Haewon Jeong, Hao Wang, Peter Michalak, Shahab Asoodeh, and Flavio Calmon, “Beyond Adult and COMPAS: Fair Multi-Class Prediction Via Information Projection,” Advances in Neural Information Processing Systems 35 (2022): 38747-38760, the disclosure of which is hereby incorporated, by reference, its entirety.

In one embodiment, the number of models may be selected based on the available computing resources.

In step 250, the computer program may compute predictive multiplicity metrics to audit predictive uncertainty for the models. For example, predictive multiplicity metrics, which measure conflicting predictions, may be computed by using the M^{K} models. In general, the greater number of models, the more accurate the computation.

In step 255, the models may be provided to the downstream tasks. For example, the model with the best fairness, the best interpretability, or the smallest predictive multiplicity may be deployed.

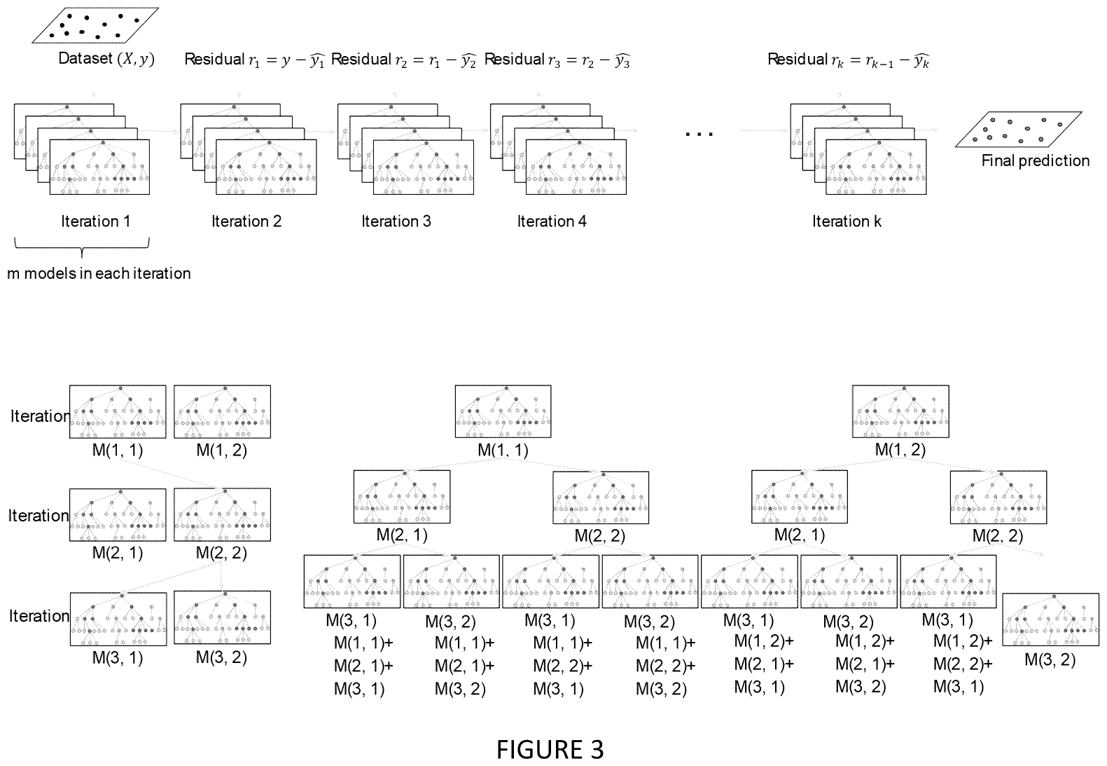

A graphical representation of the process is depicted in FIG. 3.

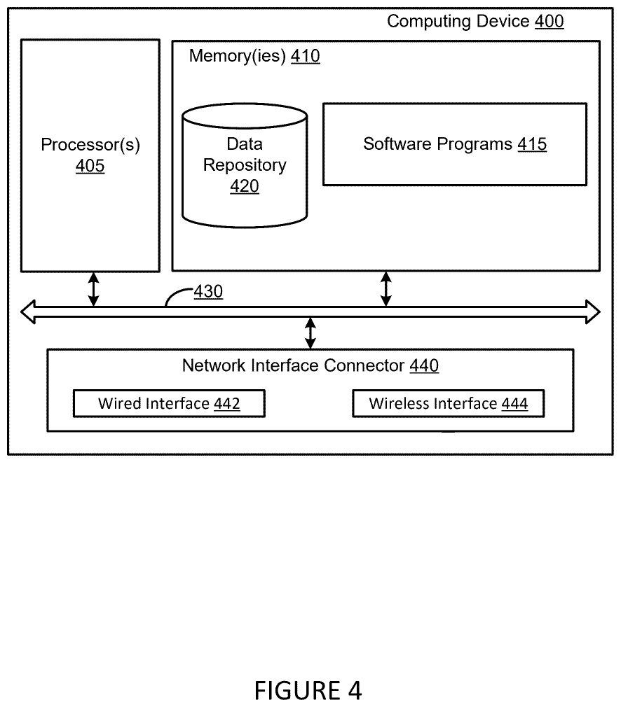

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program, a dataset comprising a plurality of samples and a loss function;
training, by the computer program, a first number of a plurality of first machine learning models using the dataset, wherein each of the plurality of first machine learning models has a similar performance as measured by the loss function;
selecting, by the computer program, one of the first machine learning models with a smallest loss using the loss function;
computing, by the computer program, a residual for each of the plurality of samples using the one first machine learning model;
defining, by the computer program, a new dataset comprising the plurality of samples and the residual for each samples;
training, by the computer program, the first machine learning model with the new dataset;
generating, by the computer program, a second plurality of machine learning models by repeating the selecting, the computing, the defining, and training for a number of boosting iterations, wherein a number of second machine learning models is equal to the first number multiplied by the number of boosting iterations;
selecting, by the computer program, a subset of the second plurality of machine learning model models having a specified property; and
deploying, by the computer program, the subset of second machine learning models to a downstream task.

2. The method of claim 1, wherein the computer program further receives the number of boosting iterations.

3. The method of claim 1, further comprising:
receiving, by the computer program, a hypothesis space comprising one of sparse decision-trees, linear models, and neural networks.

4. The method of claim 1, wherein the first plurality of machine learning models are trained with different initializations or different random seeds to fit the dataset.

5. The method of claim 1, wherein the specified property comprises fairness, and fairness is measured using a statistical parity for the plurality of second machine learning models.

6. The method of claim 1, wherein the specified property comprises interpretability, and interpretability is measured using a SHapley Additive explanations value for each of the plurality of second machine learning models.

7. The method of claim 1, further complying:
computing, by the computer program, a predictive multiplicity metric for the second plurality of machine learning models, wherein the predictive multiplicity metric measures conflicting predictions among the second plurality of machine learning models.

8. A non-transitory computer readable storage medium, including instructions stored thereon, which when read and executed by one or more computer processors, cause the one or more computer processors to perform steps comprising:
receiving a dataset comprising a plurality of samples and a loss function;
training a first number of a plurality of first machine learning models using the dataset, wherein each of the plurality of first machine learning models has a similar performance as measured by the loss function;
selecting one of the first machine learning model with a smallest loss using the loss function;
computing a residual for each of the plurality of samples using the one first machine learning models;
defining a new dataset comprising the plurality of samples and the residual for each samples;
training the first machine learning model with the new dataset;
generating a second plurality of machine learning models by repeating the selecting, the computing, the defining, and the training for a number of boosting iterations, wherein a number of second machine learning models is equal to the first number multiplied by the number of boosting iterations;
selecting a subset of the second plurality of machine learning model models having a specified property; and
deploying the subset of second machine learning models to a downstream task.

9. The non-transitory computer readable storage medium of claim 8, further including instructions stored thereon, which when read and executed by one or more computer processors, cause the one or more computer processors to receive the number of boosting iterations.

10. The non-transitory computer readable storage medium of claim 8, further including instructions stored thereon, which when read and executed by one or more computer processors, cause the one or more computer processors to perform steps comprising:
receiving a hypothesis space comprising one of sparse decision-trees, linear models, and neural networks.

11. The non-transitory computer readable storage medium of claim 8, wherein the first plurality of machine learning models are trained with different initializations or different random seeds to fit the dataset.

12. The non-transitory computer readable storage medium of claim 8, wherein the specified property comprises fairness, and fairness is measured using a statistical parity for the plurality of second machine learning models.

13. The non-transitory computer readable storage medium of claim 8, wherein the specified property comprises interpretability, and interpretability is measured using a SHapley Additive explanations value for each of the plurality of second machine learning models.

14. The non-transitory computer readable storage medium of claim 8, further including instructions stored thereon, which when read and executed by one or more computer processors, cause the one or more computer processors to perform steps comprising:
computing a predictive multiplicity metric for the second plurality of machine learning models, wherein the predictive multiplicity metric measures conflicting predictions among the second plurality of machine learning models.

15. A system, comprising:
a database storing a dataset;
a user electronic device; and
an electronic device executing a computer program that is configured to receive the dataset from the database and a loss function from the user electronic device; to train a first number of a plurality of first machine learning models using a dataset comprising a plurality of samples with different initializations or different random seeds to fit the dataset, wherein each of the plurality of first machine learning models has a similar performance as measured by the loss function; to select one of the first machine learning model with a smallest loss using the loss function; to compute a residual for each of the plurality of samples using the one first machine learning model; to define a new dataset comprising the plurality of samples and the residual for each samples; to train the first machine learning model with the new dataset; to generate a second plurality of machine learning models by repeating the selecting, the computing, the defining, and the training for a number of boosting iterations, wherein a number of second machine learning models is equal to the first number multiplied by the number of boosting iterations; to select a subset of the second plurality of machine learning model models having a specified property; and to deploy the subset of second machine learning models to a downstream task.

16. The system of claim 15, wherein the computer program further receives the number of boosting iterations.

17. The system of claim 15, wherein the computer program is further configured to receive a hypothesis space comprising one of sparse decision-trees, linear models, and neural networks.

18. The system of claim 15, wherein the specified property comprises fairness, and fairness is measured using a statistical parity for the plurality of second machine learning models.

19. The system of claim 15, wherein the specified property comprises interpretability, and interpretability is measured using a SHapley Additive explanations value for each of the plurality of second machine learning models.

20. The system of claim 15, wherein the computer program is further configured to compute a predictive multiplicity metric for the second plurality of machine learning models, wherein the predictive multiplicity metric measures conflicting predictions among the second plurality of machine learning models.
